(19) United States
(12) Patent Application Publication
(10) Pub. No.: US 2026/0349151 A1
(43) Pub. Date: Nov. 5, 2026

(54) METASURFACE STRUCTURE AND MOLD

(71) Applicant: TOPPAN Holdings Inc., Tokyo (JP)

(72) Inventors: Kazuto OONOU, Tokyo (JP); Yuki YASU, Tokyo (JP); Masashi KAWASHITA, Tokyo (JP)

(73) Assignee: TOPPAN Holdings Inc., Tokyo (JP)

(21) Appl. No.: 19/712,244

(22) Filed: Jun. 18, 2026

Related U.S. Application Data
(63) Continuation of application No. PCT/JP2024/044338, filed on Dec. 16, 2024.

(30) Foreign Application Priority Data
Dec. 21, 2023 (JP) 2023-215693
Dec. 21, 2023 (JP) 2023-215694

(51) Int. Cl. G02B 3/02

(52) U.S. Cl. CPC G02B 3/02

(57) ABSTRACT

A metasurface structure is provided with multiple nanopillars arranged on the support surface of a substrate. For the multiple nanopillars, the smaller the width or volume, the lower the height. Each nanopillar is configured to shift the phase of light having a specific wavelength according to a position at which each nanopillar is arranged on the support surface. A mold has multiple nanoholes for transferring the multiple nanopillars of the metasurface structure onto the substrate. The smaller the width or volume of the multiple nanoholes, the shallower their depth.

### CROSS-REFERENCE TO RELATED APPLICATIONS

This application claims benefit of priority to International Patent Application No. PCT/JP2024/044338, filed Dec. 16, 2024, to Japanese Patent Application No. 2023-215693, filed Dec. 21, 2023, and to Japanese Patent Application No. 2023-215694, filed Dec. 21, 2023, the entire contents of each are incorporated herein by reference.

### BACKGROUND

### Technical Field

The present disclosure relates to a metasurface structure and a mold for forming the metasurface structure.

### Background Art

In recent years, interest has grown in metasurfaces featuring nanopillars finer in size than the wavelength of light. By way of example, the metasurface can be provided with multiple nanopillars (see, for example, JP2023-37577A). The nanopillars are formed from a dielectric material through which light of a specific wavelength passes. In forming the metasurface, by adjusting the material, size, orientation, etc., of the nanopillars, it is possible to control, for example, the phase or amplitude of light incident on the metasurface, or, states of light, such as polarization caused by the metasurface.

### SUMMARY

From the perspective of more precisely controlling the state of light using the metasurfaces, reducing defective nanopillar formation is required in the metasurface manufacturing process. In other words, it is desired to more precisely control the state of light incident on the metasurface by reducing defective nanopillar formation.

As one aspect, there is provided a metasurface structure. The metasurface structure is provided with a plurality of nanopillars arranged on a support surface of a substrate The nanopillars have heights and widths such that the smaller the widths, the lower the heights. The respective nanopillars are configured to shift a phase of light having a specific wavelength, depending on positions at which the nanopillars are arranged on the support surface.

As another aspect, a mold is provided. The mold is provided with a plurality of nanoholes for transferring the plurality of nanopillars of the metasurface structure. The plurality of nanoholes have widths and depths such that the smaller the widths, the shallower the depths.

As another aspect, another metasurface structure is provided. This metasurface structure is provided with a plurality of nanopillars arranged on a support surface of a substrate. The nanopillars have volumes and widths such that the smaller the volumes, the lower the heights. The respective nanopillars are configured to shift a phase of light having a specific wavelength, depending on positions at which the nanopillars are arranged on the substrate.

As another aspect, another mold is provided. This mold is provided with a plurality of nanoholes for transferring the plurality of nanopillars of the metasurface structure onto the substrate. The plurality of nanoholes have widths and depths such that the smaller the widths, the shallower the depths.

As another aspect, a metasurface structure is provided. The metasurface structure is provided with a plurality of nanopillars arranged on a support surface of a substrate. The plurality of nanopillars include a plurality of first nanopillars arranged in a first region and a plurality of second nanopillars arranged in an annular second region surrounding the first region. The respective first nanopillars are configured to shift a phase of light having a specific wavelength, depending on positions at which the first nanopillars are arranged on the support surface.

As another mode, another mold is provided. The mold is provided with a plurality of nanoholes for transferring, to the substrate, the plurality of nanopillars on the metasurface structure. The plurality of nanoholes include a plurality of first nanoholes for transferring the plurality of first nanopillars to the substrate, the first nanoholes being arranged in a third region; and a plurality of second nanoholes for transferring the plurality of second nanopillars to the substrate, the second nanoholes being arranged in a fourth region being annular and surrounding the third region.

### BRIEF DESCRIPTION OF THE DRAWINGS

FIG. 1 is a cross-sectional view of a metalens according to the first embodiment.

FIG. 2 is a plan view of the metasurface lens according to the first embodiment.

FIG. 3 is a cross-sectional view of a mold according to the first embodiment.

FIG. 4 shows a formula (1) which represents an amount of a first phase shift.

FIG. 5 shows a formula (2) which represents an amount of a second phase shift.

FIG. 6 shows a formula (3) which represents an effective refractive index.

FIG. 7 is a table showing the evaluation results for an Example 1.

FIG. 8 is a table showing the evaluation results for a Comparative Example 1.

FIG. 9 shows a graph of the evaluation results for the Example 1 and the Comparative Example 1.

FIG. 10 is a cross-sectional view of a metalens according to the second embodiment.

FIG. 11 is a plan view showing the metalens according to the second embodiment.

FIG. 12 is a cross-sectional view of a mold according to a second embodiment.

FIG. 13 is a cross-sectional view showing the state in an Example 2, where an electron beam photoresist layer has been formed on a SOQ (Silicon on Quartz) wafer.

FIG. 14 is a cross-sectional view showing the state of the electron beam photoresist layer, which is provided after exposure performed in the Example 2.

FIG. 15 is a cross-sectional view of a metalens employed in the Example 2.

FIG. 16 is a cross-sectional view of a metalens employed in a Comparative example 2.

### DETAILED DESCRIPTION

With reference to the accompanying drawings, a metasurface structure and a mold for forming the metasurface structure, which are according to first and second embodiments, will now be described. In the following first and second embodiments, a metalens with a metasurface structure is described. The metalens possesses light transmittance, which allows light with a specific wavelength to pass through the metalens. The specific wavelength is controlled. For example, the metalens with the light transmittance controls the states of light passing through the metalens, in terms of the phase, amplitude, and/or polarization of the passing light. In contrast, the metalens may possess light reflectivity which reflects light with a specific wavelength. For example, the metalens with light reflectivity may be configured to control the states of light reflected by the metalens, in terms of the phase, amplitude, and/or polarization of the reflected light.

### First Embodiment

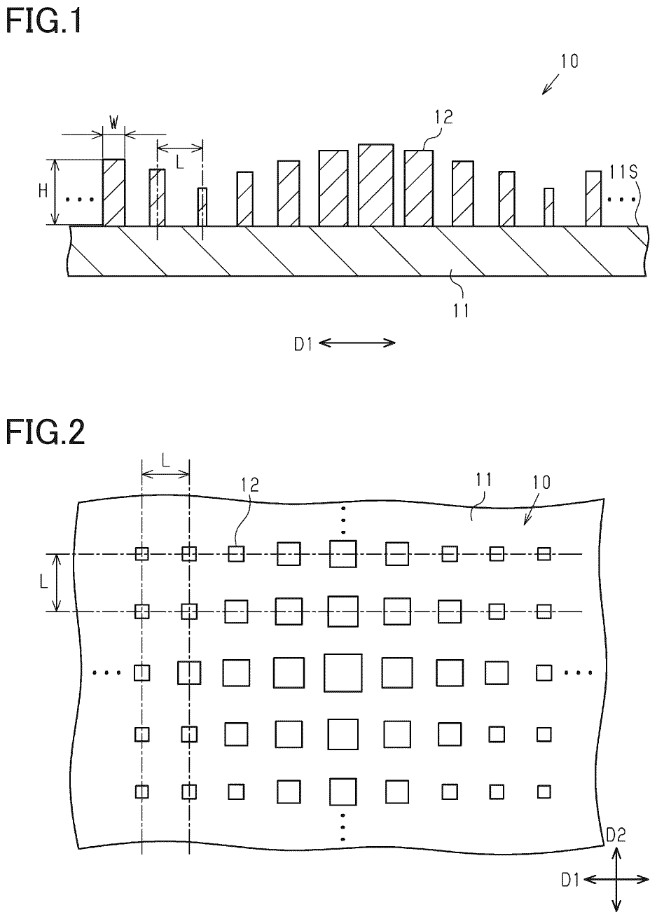

With reference to FIGS. 1 to 6, a first embodiment will now be described.

As shown in FIG. 1, a metalens 10 embodied in the first embodiment is equipped with a substrate 11 and a plurality of nanopillars 12. The substrate 11 and the plurality of nanopillars 12 are configured to possess a light transmittance which allows light with a specific wavelength to pass therethrough. In this case, the specific wavelength is to be controlled. By way of example, the metalens 10 has the function of focusing light with a specific wavelength, which is the target of control, onto a single point.

The substrate 11 may be made of glass or resin, for example, or may be formed from multiple layers combining these materials. The substrate 11 provides a support surface 11S that supports the multiple nanopillars 12.

Using nanopillars 12, the metalens 10 controls the state of light having a specific wavelength to be controlled. In other words, the metalens 10 has a nanosurface structure which includes the multiple nanopillars 12. The nanopillars 12 according to the first embodiment deflect light having a specific wavelength to be controlled, depending on the position of each nanopillar 12 on the support surface 11S.

The nanopillars 12 are formed from a dielectric material having any refractive index greater than 1. The material forming the nanopillars 12 may be silicon-based material such as single-crystal silicon, polycrystalline silicon, or amorphous silicon; inorganic materials such as titanium dioxide; or resin material such as polymeric materials that function as dielectric materials.

As shown in FIG. 2, in the metalens 10, the multiple nanopillars 12 are periodically arranged along each of a first direction D1 and a second direction D2. The first direction D1 and the second direction D2 are mutually orthogonal directions.

For example, the multiple nanopillars 12 are arranged along each of the first direction D1 and the second direction D2 with a predetermined orientation and a predetermined pitch L. The pitch L refers to the distance between the centers of adjacent nanopillars 12 in each of the first direction D1 and the second direction D2. For example, the multiple nanopillars 12 are arranged in a square pattern with a constant pitch L. The pitch L is, for example, 100 nm or more and 10 μm or less. It is noted that the pitch L and the orientation of the nanopillars 12 need not be constant and may differ from each other in the first direction D1 and the second direction D2.

As shown in FIG. 1, each of the nanopillars 12 is formed as a rectangular prism. The multiple nanopillars 12 include two or more nanopillars 12 configured such that the two or more nanopillars 12 have mutually different heights H and widths W, and such that the height H decreases as the width W decreases. In addition, the multiple nanopillars 12 include two or more nanopillars 12 configured such that the two or more nanopillars 12 have mutually different heights H and volumes, and such that the height H decreases as the volume decreases.

In the present embodiment, the width W refers to the dimension of the nanopillars 12 in the first direction D1. In addition, the nanopillars 12 also have the same dimensions in the second direction D2 as those in the first direction D1. That is, the nanopillars 12 are configured such that, every nanopillar, the width in the second direction D2 is equal to the width W in the first direction D1.

As one example, the width W of the nanopillars 12 is an average width which is measured between the upper and the lower ends of nanopillars 12. As another example, the width W of nanopillars 12 is an average of the width measured at the upper end and the width measured at the lower end of nanopillars 12. In yet another example, the width W of the nanopillars 12 may be a maximum width measured between the top and bottom ends of the nanopillars 12. The width W of the nanopillars 12 is substantially equivalent to or smaller than the specific wavelength of the light, where the specific wavelength is to be controlled.

The multiple nanopillars 12 are arranged such that, for example, the height H and width W of each nanopillar 12 periodically change on the support surface 11S, depending on the position where each nanopillar 12 is arranged in each of the first direction D1 and the second direction D2.

### Manufacturing Method of Metalens 10

One example of a method for manufacturing the metalens 10 involves combining multiple processing steps such as electron beam lithography, dry etching, and ion beam processing. This results in the formation of multiple nanopillars 12 made of inorganic material on the support surface 11S of the substrate 11. Another example of a method for manufacturing the metalens 10 involves using physical or chemical vapor deposition or atomic layer deposition (ALD) to deposit or lift-off inorganic material onto a pattern formed on the support surface 11S of the substrate 11, using electron beam lithography. This results in the formation of nanopillars 12. Another example of a method for manufacturing the metalens 10 involves using a mold with a nanoholes pattern formed by inverting the nanopillars 12, such as by dry etching or electroforming, to transfer a resin functioning as a dielectric material onto the support surface 11S of the substrate 11. This also results in the formation of nanopillars 12.

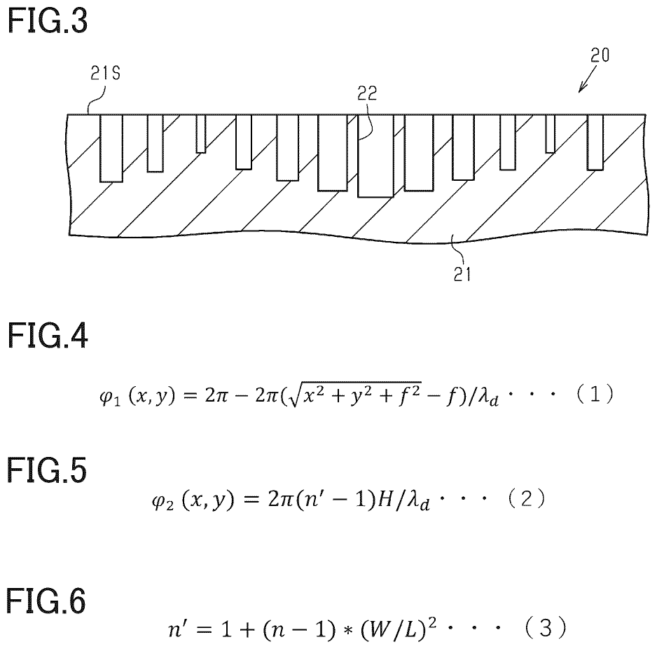

FIG. 3 shows a mold 20 for transferring the nanopillars 12 formed by resin onto a substrate 11. The mold 20 includes a base 21. The material forming the base 21 is, for example, an inorganic material such as silicon or a metal. The base 21 has a first surface 21S. A plurality of nanoholes 22 are formed on the first surface 21S of the base 21.

The mold 20 is used to transfer the resin filled into nanoholes 22 onto the support surface 11S of the substrate 11. Hence, the nanoholes 22 have a shape that is the inverse of the multiple nanopillars 12 provided by the metalens 10. Specifically, the plurality of nanoholes 22 includes two or more nanoholes 22 having mutually different widths and depths, where the shallower the depth from the first surface 21S, the smaller the width. In addition, the plurality of nanoholes 22 have volumes and depths that differ from one another, and include two or more nanoholes 22, where the shallower the depth from the first surface 21S, the smaller the volume.

By way of example, the nanoholes 22 are formed by performing dry etching on the first surface 21S of the base 21. When the dry etching is used as the manufacturing process for the mold 20, the micro-loading effect can be utilized to vary the depths of the nanoholes 22 in accordance with the widths of the nanoholes. Alternatively, the nanoholes 22 may be formed by electroforming onto a resist pattern of nanopillars with varying heights, formed by electron beam lithography. When the electron beam lithography is used as the manufacturing process for the mold 20, the height of the resist pattern (pillar width) can be varied depending on the width of the resist pattern by utilizing differences in development speed due to exposure amount.

### Light Control Mode in Producing Metalens 10

Referring to FIGS. 4 to 6, a mode for controlling light in producing the metalens 10 will now be described.

The metalens 10 is able to focus light transmitted therethrough onto a single point (focus) by refracting light incident on the respective nanopillars 12. Specifically, each of the nanopillars 12 shifts the phase of light having a specific wavelength to be controlled, depending on which position each nanopillar 12 is arranged on the support surface 11S.

For example, for the metalens 10, the first phase shift amount φ₁ required by each nanopillar 12 is given by formula (1) shown in FIG. 4. In formula (1), a reference symbol f represents the design focal length of the metalens 10. A reference symbol λ_{d} is the wavelength of the light to be controlled. Reference symbols x and y represent the coordinates of each nanopillar 12 when the origin is set at the intersection point between the perpendicular line drawn from the focal point to the metalens 10 and the metalens 10 itself. For example, the reference symbol x represents the distance along the first direction D1 from the origin to the respective nanopillars 12. The reference symbol y represents the distance along the second direction D2 from the origin to the respective nanopillars 12.

Furthermore, the second phase shift amount φ₂ generated at each nanopillar 12 is given by formula (2) shown in FIG. 5, which uses the height H of each nanopillar 12, the effective refractive index n′ at each nanopillar 12, and the wavelength λ_{d} of the light to be controlled. The effective refractive index n′ refers to the averaged refractive index of a unit space of a predetermined size when multiple media with different refractive indices exist within the unit space and parameters such as the refractive index and thickness of each medium are considered. In each of the first and second directions D1 and D2, the width of the unit space is equal to the pitch L. The height of the unit space is equal to the height H of each of the nanopillars 12. The unit space encloses one nanopillar 12. It is noted that the multiple media within the unit space refer to air and each of the nanopillars 12.

The effective refractive index n′ is given by formula (3) shown in FIG. 6, using the refractive index n of the material forming the nanopillars 12, the width W of each of the nanopillars 12, and the pitch L with which the multiple nanopillars 12 are arranged.

Thus, the shape of each nanopillar 12 is determined according to the position and material of the nanopillars 12 such that the second phase shift amount φ₂ equals the first phase shift amount φ₁, thereby focusing the light transmitted through each nanopillar 12 onto a focal point. In other words, the second phase shift amount φ₂ given by each nanopillar 12 is specified such that the plurality of nanopillars 12 collectively function as a condensing lens.

In the plurality of nanopillars 12 having a predetermined pitch L and refractive index n, it is assumed that light transmitted through the metalens 10 is focused to a focusing point. In this case, specifically, the second phase shift amount φ₂ is required to be adjusted within the range of 0 degrees or more and 360 degrees or less (0 [rad] or more and 2π [rad] or less) according to the positions of the nanopillars 12.

For example, in formula (3), the value of W/L, which represents the ratio of the widths W of the nanopillars 12 to the pitch L, can be adjusted within the range of 0.2 or more and 0.8 or less by changing the widths W of the nanopillars 12. In formula (3), the value of n, representing the refractive index of the material, is determined according to the material forming the nanopillars 12. Hence, to achieve an adjustment range of 0 degrees or more and 360 degrees or less for the second phase shift amount φ₂ expressed by formula (2), it is preferable to make the heights H of the nanopillars 12 as large as possible.

On the other hand, if the aspect ratio (H/W) representing the height H relative to the width W becomes excessively large for each nanopillar 12, stable patterning of the nanopillars 12 becomes difficult during the manufacturing process of the metalens 10. For example, when forming the nanopillars 12 by dry etching or lift-off, a larger aspect ratio of the resist pattern may result in formation defects such as pattern collapse. In the case of the transfer process, a larger aspect ratio increases the likelihood of insufficient resin filling into the mold 20 or insufficient strength of the nanopillars 12.

Hence, the nanopillars 12 according to the first embodiment are configured such that the height H decreases as the volume or width W becomes smaller, or the height H increases as the volume or width W becomes larger. This size or volume setting suppresses the aspect ratio of each nanopillar 12 from becoming excessively large.

The aspect ratio (H/W) of each nanopillar 12 is preferably less than 3.5, and more preferably 3.1 or less. By keeping the aspect ratio within the above range, it is possible to suppress formation defects in the manufactured nanopillars 12 while ensuring an adjustment range for the second phase shift amount φ₂.

In addition, it is preferable that the nanopillars 12 are configured such that, for each nanopillar, the aspect ratio decreases as the height H increases. This facilitates the manufacturing of the metalens 10 and the manufacturing of the mold 20 used to produce the metalens 10.

### Advantages of the First Embodiment

(1-1) In the metalens 10, the multiple nanopillars 12 are configured such that the height H decreases as the width W or volume becomes smaller. This allows the adjustable range of the second phase shift amount φ₂ to be secured while suppressing an excessively large aspect ratio of the nanopillars 12, compared to a configuration where the height H of the nanopillars 12 is constant. Hence, since defects in forming the multiple nanopillars 12 can be suppressed, the state of light incident on the multiple nanopillars 12 can be controlled with greater precision. In addition, in the configuration of the first embodiment, the adjustable range of the second phase shift amount φ₂ can be secured even when the refractive index n is relatively low, thereby broadening the selection of materials for forming the nanopillars 12.
(1-2) The nanopillars 12 provided in the first embodiment have rectangular prisms. If the nanopillars 12 have a distribution of effective refractive indexes in the height direction, light incident on the nanopillars 12 may become difficult to transmit therethrough. In this regard, if the nanopillars 12 are rectangular prisms, the nanopillars 12 possess a uniform effective refractive index in the height direction. This prevents the shape of the nanopillars 12 from affecting the transmittance of incident light.
(1-3) The aspect ratio (H/W) of each nanopillar 12 is set to less than 3.5, preferably 3.1 or less. This allows for the optimal balance between ensuring the adjustment range of the second phase shift amount φ₂ and suppressing formation defects in the nanopillars 12.
(1-4) The second phase shift amount φ₂ at each nanopillar 12 is defined such that multiple nanopillars 12 collectively function as a lens. This enables, for example, the metalens 10 according to the first embodiment to function as a condensing lens that concentrates light incident on multiple nanopillars 12 onto a single point.
(1-5) The mold 20 is provided with multiple nanoholes 22 with varying widths and depths. Using such a mold 20, the multiple nanopillars 12 with different heights H and widths W can be formed in a single processing step. A dry etching process can be used to manufacture the mold 20. Thus, the processing that increases the depth of the nanoholes 22 in proportion to their width can be easily performed based on the micro-loading effect.

### Modification of the First Embodiment

The foregoing first embodiment may be implemented with the following modifications. In addition, such modifications may be combined within the scope of technical feasibility.

The first embodiment described the metalens 10 having a metasurface structure. Specifically, in the first embodiment, a configuration where multiple nanopillars 12 provided by the metasurface structure collectively function as a condensing lens. Without being limited to such a configuration, there can be provided a modification where multiple nanopillars 12 may function as phase-control lenses that control the phase of light for purposes other than light collection (e.g., light dispersion), or as spectroscopic lenses that disperse light by wavelength. Alternatively, multiple nanopillars 12 may function as polarization control lenses that selectively transmit only specific polarization components or control the polarization state of transmitted light by altering its polarization state. As another alternative, by arranging the multiple nanopillars 12 on a reflector, the multiple nanopillars 12 may function in a form other than a lens to reflect light having a specific wavelength in an arbitrary direction.

The aspect ratio of each nanopillar 12 is not limited to a range which is less than 3.5. For example, nanopillars 12 with an aspect ratio of 3.5 or greater may be included, provided this does not interfere with the manufacturing process of the metalens 10. Alternatively, nanopillars 12 with an aspect ratio of 1 or less may be included, provided that the foregoing adjustment range for the second phase shift amount φ₂ can be secured.

The shape of the nanopillars 12 is not limited to rectangular prisms, but, for example, the shapes may also be cylindrical. When the nanopillars 12 are formed as cylindrical shapes, the diameter of the cylindrical shape corresponds to the width W. Even in such a cylindrical shape, the nanopillars 12 possess a uniform effective refractive index in the height direction. This also prevents the shape of the nanopillars 12 from affecting the transmittance of incident light. As another modification, the shape of the nanopillars 12 may be any arbitrary shape other than rectangular prisms or cylindrical shapes. For example, the shape of the nanopillars 12 may be any rectangular prism, such as a square pyramid, or may be a conical pyramid. It is noted that similar modifications are also possible for the shape of the nanoholes 22.

In the foregoing embodiment, the nanopillars 12 are illustrated as having the same width W in both the first direction D1 and the second direction D2, but other configurations are also possible. By way of example, the width in the second direction D2 may differ from the width W in the first direction D1. In such a case, it is preferable that at least one of the first aspect ratio, representing the ratio of height H to width W in the first direction D1, and the second aspect ratio, representing the ratio of height H to width in the second direction D2, is less than 3.5, more preferably 3.1 or less. Alternatively, it is more preferable if both the first aspect ratio and the second aspect ratio are less than 3.5, more preferably 3.1 or less.

At least some of the multiple nanopillars 12 may be configured such that the height H decreases as the width W decreases. For example, the multiple nanopillars 12 may include two nanopillars 12 having substantially equivalent width W but different heights H. For example, the plurality of nanopillars 12 may include nanopillars 12 having a width W greater than that of a specific nanopillar 12 and a height H lower than that of such a specific nanopillar 12. The foregoing similar modifications are also possible for the plurality of nanoholes 22.

At least some of the multiple nanopillars 12 may be configured such that the height H decreases as the volume decreases. For example, the plurality of nanopillars 12 may include two nanopillars 12 having substantially equivalent volumes but different heights H. Still, for example, the plurality of nanopillars 12 may include nanopillars 12 having a larger volume than that of a specific nanopillar 12 and a height H lower than that of the specific nanopillar 12. Additionally, for example, in a plurality of nanopillars 12, when viewed from above, a mixture of nanopillars 12 having a rectangular prism shape and nanopillars 12 having a cylindrical shape may be present, and the volume of the rectangular prisms may be equal to or greater than the volume of the cylinders. In such a modification, when regarding the radius of the cylindrical shape as the width W, the width W (diameter) and height H of the cylindrical nanopillars 12 can be made larger than the width W and height H of the rectangular prism nanopillars 12. Similar modifications to the foregoing are possible for the multiple nanoholes 22.

In the metalens 10, the arrangement of multiple nanopillars 12 may be determined as appropriate based on the intended use of the metalens 10. Alternatively, the multiple nanopillars 12 may not be limited to a configuration where the multiple nanopillars 12 are arranged in a square array in both the first direction D1 and the second direction D2. For example, the multiple nanopillars 12 may be arranged outward from any point on the substrate 11, according to the distance from the point on the substrate 11, which point serves as the center. As another alternative, the pitch L and the orientation of the nanopillars 12 need not be constant.

### Examples and Comparative Examples of the First Embodiment

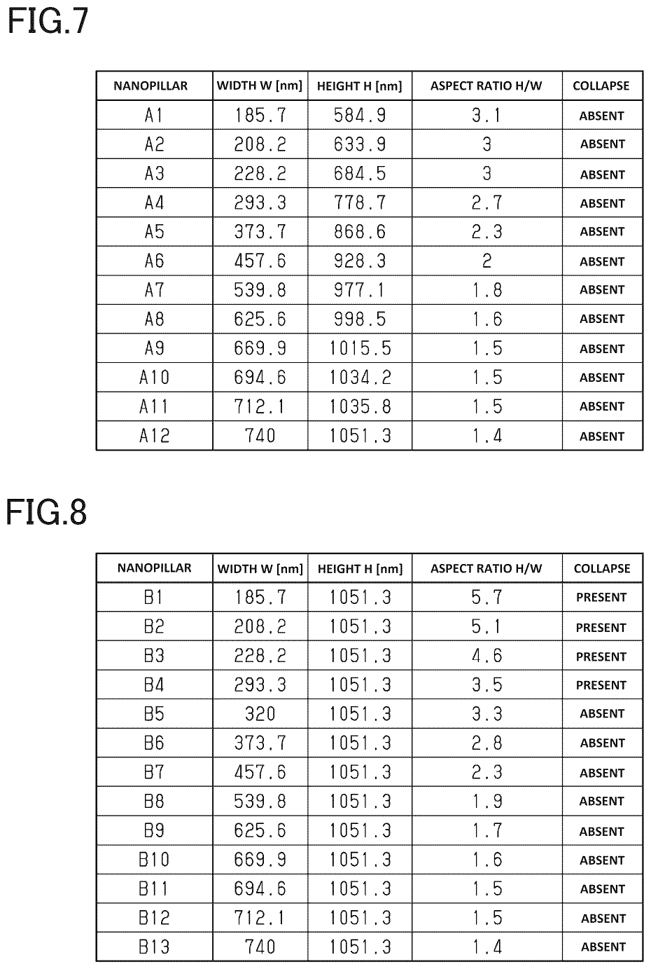

Referring to FIGS. 7 to 9, an Example 1 and a Comparative Example 1 according to the first embodiment will now be described. It is noted that the following Examples do not limit the scope of the present disclosure.

### Example 1: Mold Fabrication

In an Example 1, a metalens 10 containing nanopillars 12 with varying heights H and widths W was fabricated. First, a mold 20 was fabricated to transfer the nanopillars 12 onto a substrate 11.

First, an electron beam photoresist material was coated onto a silicon wafer with a diameter of 200 mm using a spin coater. The operating conditions of the spin coater were set to a rotation speed of 700 rpm and a spin time of 120 seconds. This made it possible to form an electron beam photoresist layer with a thickness of 500 nm on the silicon wafer. Subsequently, the electron beam photoresist material coated on the silicon wafer was pre-baked using a hot plate to remove residual solvents contained within the electron beam photoresist material. The pre-bake conditions were a heating temperature of 120 °C and a heating time of 5 minutes.

Then, a nanohole pattern was drawn on the electron beam photoresist layer on the silicon wafer by exposing the layer. An electron beam lithography system was used for exposure. During the exposure, an electron beam was irradiated at an acceleration voltage of 100 keV. The exposure dose was set to 18 μC/cm². The nanoholes were patterned with a square array with a pitch L of 800 nm.

Then, a square nanoholes pattern was formed by developing the exposed portion, hereinafter referred to as the exposed area, of the electron beam photoresist layer. Specifically, the nanoholes pattern was formed by dissolving the exposed area through developing the exposed area for 60 seconds using an alkaline developer (product name: SD-1, manufactured by Tokuyama Corporation). Subsequently, the developer was removed from the electron beam photoresist layer on the silicon wafer by rinsing with ultrapure water, followed by drying in a spin dryer. The width of the openings in the nanoholes pattern formed in the electron beam photoresist layer was within the range of 140 nm or more and 700 nm or less.

Then, dry etching was performed on the silicon wafer coated with the electron beam photoresist layer containing the nanoholes pattern, thereby transferring the nanoholes pattern onto the silicon wafer. A mixed gas containing SF₆ and C₄F₈ was used as the etching gas. The etching time was set to 300 seconds. In the dry etching process, adjusting factors such as the amount of etching gas allows the depth of the silicon holes to be varied according to their widths, which is due to gain the micro-loading effect. In this Example, the etching conditions were adjusted so that the width of the silicon holes were within the range of 180 nm or more and 740 nm or less (i.e., 180 nm to 740 nm), and the depth of the silicon holes were within the range of 580 nm or more and 1060 nm or less (i.e., 580 nm to 1060 nm).

Finally, the electron beam photoresist layer was removed by cleaning processes. Specifically, the silicon wafer with the electron beam photoresist layer was immersed in a mixture of sulfuric acid and hydrogen peroxide solution (80 °C) for 10 minutes, rinsed with ultrapure water, immersed in a mixture of ammonia and hydrogen peroxide solution at room temperature for 10 minutes, and then rinsed again with ultrapure water. These processes were performed in this sequence. Through such cleaning steps, a silicon mold, which is an example of the mold 20, was obtained.

### Example 1: Fabrication of the Metalens

Next, a metalens 10 was fabricated by transferring the nanopillars 12 onto a substrate 11 using the above-mentioned silicon mold. A 125 mm square glass substrate was used as the substrate 11. First, an ultraviolet-curable resin was coated onto the support surface 11S of the substrate 11. While pressing the silicon mold onto the ultraviolet-curable resin, light with a wavelength of 365 nm was irradiated from the substrate 11 side to cure the ultraviolet-curable resin. Subsequently, the UV-curable resin was demolded from the silicon mold, thus forming nanopillars 12 composed of the cured UV-curable resin on the support surface 11S of the substrate 11. In Example 1, twelve nanopillar patterns, nanopillars A1 to A12, having mutually different widths W and heights H were formed. The used UV-curable resin had a refractive index of 1.99 after curing, for light having a wavelength of 850 nm, which is the target wavelength for control.

### Comparative Example 1: Fabrication of the Metalens

In a Comparative Example 1, the metalens 10 was fabricated using the same procedure as that explained in the Example 1, except that the depth of the silicon holes was kept constant, i.e., the height H of the nanopillars 12 was kept constant. In the comparative Example 1, thirteen patterns of the nanopillars 12, nanopillars B1 to B13 were formed, each having the same height H but different widths W. In the comparative Example 1, the height H of the nanopillars 12 was set to 1051.3 nm, which corresponds to the maximum height H which is set in the Example 1.

### Evaluation: Dimensional Measurement and Visual Inspection

The metalens 10 obtained from the Example 1 and the Comparative Example 1 were cut, and images of those cut nanopillars 12 were acquired using FE-SEM. For each nanopillar 12, the width W and height H were measured on the acquired images. The measurement results for the Example 1 are shown in FIG. 7. Moreover, the measurement results for the Comparative Example 1 are shown in FIG. 8. Additionally, the results of the visual inspection for each nanopillar 12 regarding the presence or absence of collapse are shown in FIGS. 7 and 8.

As shown in FIG. 7, in the case of Example 1, the width W of nanopillars 12 was within the range of 185.7 nm or more and 740 nm or less. The height H of the nanopillars 12 was within the range of 584.9 nm or more and 1051.3 nm or less. The aspect ratio (H/W) of the nanopillars 12 was within the range of 1.4 or more and 3.1 or less. In addition, the nanopillars 12 were configured such that the smaller the width W of the nanopillars 12, the lower the height H of the nanopillars 12. The nanopillars 12 were configured such that the higher the height H of the nanopillars 12, the smaller the aspect ratio of the nanopillars 12. In the Example 1, no collapse of the nanopillars 12 was observed.

As shown in FIG. 8, in the structure provided by the Comparative Example 1, the width W of the nanopillars 12 was within the range of 185.7 nm or more and 740 nm or less. The height H of the nanopillars 12 was constant at 1051.3 nm. The aspect ratio of nanopillars 12 was within the range of 1.4 or more and 5.7 or less. In the Comparative Example 1, collapse was confirmed in nanopillars 12 having an aspect ratio of 3.5 or greater.

### Evaluation: Phase Shift Amount

For each nanopillar 12 of the metalens 10 provided in the Example 1 and the Comparative Example 1, the phase of the transmitted light at a predetermined position was calculated by performing Rigorous Coupled-Wave Analysis (RCWA). Then, for both the Example 1 and Comparative Example 1, the phase shift amount for each nanopillar 12 was calculated as the phase difference from the reference phase at the nanopillar 12 with the smallest width W. In the Example 1, a nanopillar A1 with a width W of 185.7 nm was used as the reference, i.e., its phase shift amount=0 degrees. In the Comparative Example 1, a nanopillar B5, which had the smallest width W (320 nm) among the nanopillars 12 that had not collapsed, was used as the reference, i.e., its phase shift amount=0 degrees.

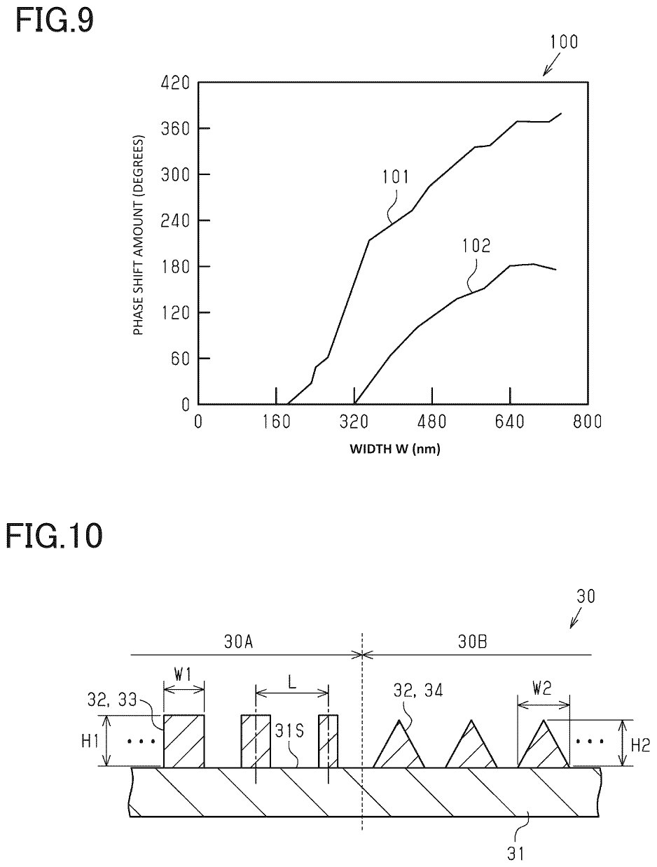

In a graph 100 shown in FIG. 9, the horizontal axis represents the width W of the nanopillars 12, while the vertical axis represents the phase shift amount of light transmitted through the nanopillars 12. A curve 101 shown in the graph 100 represents the phase shift amount of light transmitted through the nanopillars 12, as a function of nanopillar width W in the Example 1. A curve 102 shown in the graph 100 represents the phase shift amount of light transmitted through the nanopillars 12, as a function of nanopillar width W in the Comparative Example 1.

As shown in FIG. 9, in the Example 1 where the width W and height H were varied, it was confirmed that the phase shift amount could be adjusted within a range from 0 degrees to 381.9 degrees, when the evaluation was performed based on, as a reference, the nanopillars A1 with a width W of 185.7 nm. On the other hand, in the Comparative Example 1, where only the width W was varied while keeping the height H constant, it was confirmed that the adjustable range of the phase shift amount was limited to 0 to 196.6 degrees, when the evaluation was performed based on, as a reference, the nanopillars B5 with a width of 320 nm. Therefore, it was confirmed that in the metalens 10, the nanopillars 12 should be configured such that the height H decreases as the width W or volume decreases. This allows for a wider range of phase shift amount adjustment compared to that obtained when the height H is kept constant.

### Second Embodiment

With reference to FIGS. 10 to 12, a second embodiment will now be described.

As shown in FIG. 10, a metalens 30 according to the second embodiment is provided with a substrate 31 and a plurality of nanopillars 32. The plurality of nanopillars 32 are arranged on a support surface 31S provided on the substrate 31. The substrate 31 and the plurality of nanopillars 32 possess light transmittance that enables light with a specific wavelength to be controlled, to be transmitted therethrough. As one example, the metalens 30 has the function of focusing light having the specific wavelength to be controlled onto a single point.

The metalens 30 controls the state of light having the specific wavelength to be controlled, by using the nanopillars 32. Specifically, the nano-surface structure of the metalens 30 is provided with multiple nanopillars 32. The substrate 31 may be composed of the same material as that of the substrate 11 described in the first embodiment. The nanopillars 32 may also be composed of the same material as that of the nanopillars 12 described in the first embodiment.

The plurality of nanopillars 32 are provided with multiple first nanopillars 33 and multiple second nanopillars 34. The multiple first nanopillars 33 are arranged in a first region 30A. The multiple second nanopillars 34 are arranged in a second region 30B. The first nanopillars 33 and second nanopillars 34 are arranged in a square pattern with a fixed pitch L.

Each of the first nanopillars 33 shifts the phase of light having the specific wavelength according to the position within the support surface 31S where that first nanopillar 33 is arranged. The first nanopillars 33 are formed, for example, as rectangular prisms. The first nanopillars 33 have, for example, a fixed height H1. In the metalens 30 of the second embodiment, the width W1 of the first nanopillars 33 is changed. This causes the light transmitted through each first nanopillar 33 to be focused.

Hence, the shape of each first nanopillar 33 is determined according to the position and material of the first nanopillars 33 so that the second phase shift amount φ₂ equals the first phase shift amount φ₁, thereby focusing he light transmitted through each first nanopillar 33 onto a focal point. In other words, the second phase shift amount φ₂ at each first nanopillar 33 is specified such that the plurality of first nanopillars 33 collectively function as a condensing lens.

The plurality of second nanopillars 34 have mutually identical shapes. As one example, each of the second nanopillars 34 has a shape where the width W2 decreases toward the tip thereof, provided that the substrate 31 side is taken as the base end. For example, the second nanopillars 34 respectively have a needle-like structure or a conical shape that tapers toward the tip. In other words, the cross-sectional area of each of the second nanopillars 34 in a plane perpendicular to the height direction changes stepwise or continuously along the height direction. Thus, the second nanopillars 34 are configured such that their effective refractive indexes change stepwise or continuously along the height direction. Hence, the second nanopillars 34 can act as a Moth-eye structure that minimizes the reflection and refraction of incident light. For example, the second nanopillars 34 may have a constant height H2. Alternatively, the height H2 of the second nanopillars 34 may be the same as or different from the height H1 of the first nanopillars 33.

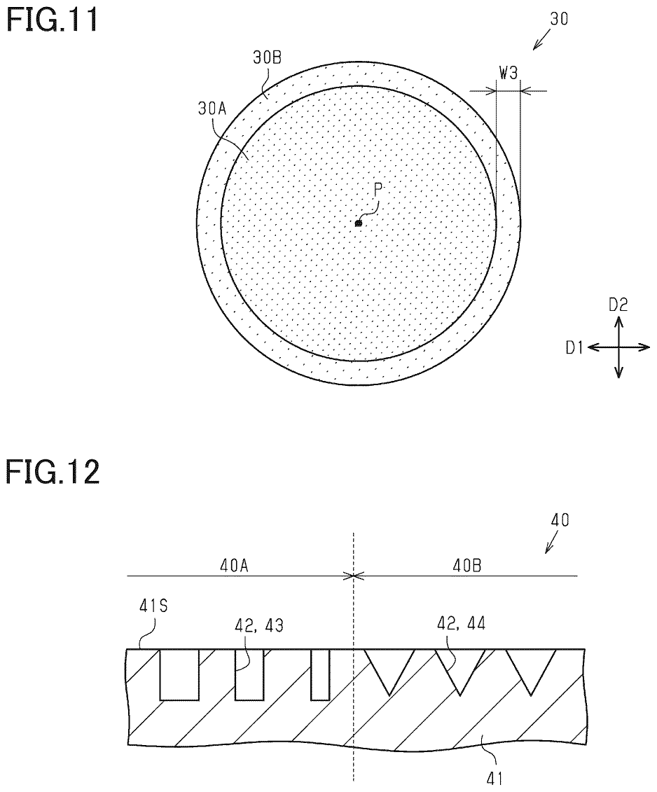

As shown in FIG. 11, by way of example, the metalens 30 has a circular shape when viewed from above. The metalens 30 is provided with a first region 30A including a circular shape when viewed from above and a second region 30B surrounding the first region 30A. The second region 30B has a top-view annular shape. A plurality of first nanopillars 33 are arranged in the first region 30A. A plurality of second nanopillars 34 are arranged in the second region 30B. In FIG. 11, the first region 30A and the second region 30B are depicted using dots of different densities.

As an example, a plurality of nanopillars 32 are arranged in a square array such that the nanopillars 32 have a predetermined pitch L along each of the first direction D1 and the second direction D2. The plurality of first nanopillars 33 are arranged to have widths W which are periodically changed in each of the first direction D1 and the second direction D2, for example. It is noted that the pitch L and the orientation of the nanopillars 32 need not be constant.

For example, the plurality of first nanopillars 33 arranged in the first direction D1 have an array pattern serving as a single repeating unit, wherein the first nanopillars 33 with a smaller width W are arranged from the center P side toward the periphery side of the metalens 30. In the first region 30A, the multiple first nanopillars 33 are arranged such that numerous repeating units are arranged from the center P toward the periphery of the metalens 30. For example, the length of one repeating unit in the first direction D1 is 0.1 μm or more and 10 μm or less. Furthermore, in the first region 30A, the second direction D2 is also configured with an arrangement pattern which is similar or identical to the foregoing.

The second region 30B has a radial width W3. The lower limit of the width W3 is, for example, at least 10 μm or more, preferably 100 μm or more. The upper limit of the width W3 is not particularly limited, but is, for example, 1 mm or less, preferably 500 μm or less.

The metalens 30 is not limited to a circular shape when viewed from above and may have any shape. Similarly, the shape of the first region 30A is also not limited to a circular shape when viewed from above and may have any shape. In the same way, the shape of the second region 30B is not limited to a circular ring shape when viewed from above and may be any ring-shaped structure that surrounds the first region 30A.

### Manufacturing Method for Metalens 30

The metalens 30 according to the second embodiment can be manufactured using the same manufacturing method as the metalens 10 described in the first embodiment.

FIG. 12 shows a mold 40 for transferring the nanopillars 32, which are composed of resin, onto the substrate 31. The mold 40 includes a base 41. The base 41 may be composed of the material similar or identical to that of the base 21 adopted in the first embodiment, for example.

The base 41 has a first surface 41S. A plurality of nanoholes 42 are formed on the first surface 41S of the base 41. The nanoholes 42 are formed by performing dry etching or electroforming, or other necessary treatments, on the first surface 41S of the base 41.

The multiple nanoholes 42 include a plurality of first nanoholes 43 for transferring the multiple first nanopillars 33 onto the substrate 31, and a plurality of second nanoholes 44 for transferring the multiple second nanopillars 34 onto the substrate 31.

Each of the multiple nanoholes 42 has a shape that is the inverse of a corresponding one of the multiple nanopillars 32 provided by the metalens 30. Specifically, each of the first nanoholes 43 has a shape that is the inverse of a corresponding one of the first nanopillars 33. Moreover, each of the second nanoholes 44 has a shape that is the inverse of a corresponding one of the second nanopillars 34.

The mold 40 has a third region 40A and a fourth region 40B. The plurality of first nanoholes 43 are arranged in the third region 40A. The plurality of second nanoholes 44 are arranged in the fourth region 40B. The third region 40A is configured in a circular shape corresponding to the first region 30A. The fourth region 40B is configured as a ring corresponding to the second region 30B.

### Operation of the Second Embodiment

In the manufacturing processes of the metalens 30, when forming the nanopillars 32 on the substrate 31, a decrease in the pattern density, which refers to the density of the nanopillars 32 surrounding each nanopillar 32 to be formed, makes it easier for nanopillar 32 formation defects to occur.

The pattern density refers to the ratio of the occupied area occupied by the nanopillars 32 within a virtual region centered at any position on the metalens 30, as viewed from the top view which is opposed to the support surface 31S. The virtual region for calculating the pattern density may be rectangular or circular. The virtual region encompasses multiple nanopillars 32. For example, the virtual region may encompass one or more repeating units formed by the plurality of first nanopillars 33. As one example, the virtual region may be configured as a circular shape having a radius of 10 μm or more and 100 μm or less.

For example, the pattern density is calculated from SEM images captured from a position which is opposed to the support surface 31S. For example, from an SEM image capturing a virtual region containing multiple nanopillars 32, the ratio of the area of nanopillars 32 within the virtual region to the total area of the virtual region is calculated. When calculating the pattern density, image processing such as binarization may be applied to the SEM image to distinguish the portion where the nanopillars 32 are arranged from the remaining portion.

In the first region 30A of the metalens 30, multiple first nanopillars 33 having mutually different widths W1 are periodically arranged. Thus, most of the first region 30A is able to have a substantially constant pattern density.

However, if the second nanopillars 34 are not formed in the second region 30B, the area near the outer edge of the first region 30A will include regions where the first nanopillars 33 are not formed within the virtual region used to calculate the pattern density. Thus, if the second nanopillars 34 are not formed in second region 30B, the pattern density decreases sharply as one approaches the outer edge of first region 30A on the metalens 30.

The sharp change in the pattern density near the outer edge of the first region 30A may sometimes cause processing defects during the manufacturing processes of the metalens 30. For example, in electron beam lithography, due to the proximity effect, regions with lower pattern density experience a reduction in the effective exposure dose. In this case, regions with lower pattern densities are more prone to insufficient exposure, thus leading to pattern formation defects. The proximity effect refers to the phenomenon where electron beam energy diffuses due to scattering or reflection on the resist surface or substrate 31. In addition, such phenomena can occur not only during the fabrication of the metalens 30 using electron beam lithography but also during the fabrication of the mold 40 using electron beam lithography.

For example, in the dry etching process, due to the micro-loading effect, etching rates increase in areas with lower pattern densities. Thus, areas with lower pattern densities are more prone to excessive etching depths, thus leading to pattern formation defects. In addition, in processes such as a transfer process using the mold 40, formation defects like filling failures or variations in residual film thickness are more likely to occur due to sharp changes in the pattern density.

In this regard, the metalens 30 according to the second embodiment includes a second region 30B where the second nanopillars 34 are arranged to surround the first region 30A where the first nanopillars 33 are arranged to shift the phase of light having the specific wavelength. Thus, the second nanopillars 34 arranged in the second region 30B can suppress the sharp change in the pattern density near the outer edge of the first region 30A.

For example, the pattern density of the first virtual region, which includes the first nanopillars 33 of the first region 30A but does not include the second nanopillars 34 of the second region 30B, is denoted as the first pattern density ρ1. The pattern density of the second virtual region, which includes the second nanopillars 34 of the second region 30B but does not include the first nanopillars 33 of the first region 30A, is denoted as the second pattern density ρ2.

In the present embodiment, the first virtual region and the second virtual region are circular in shape, each having the same radius. This radius is sufficiently large to encompass at least one repeating unit of the first nanopillars 33 within the first virtual region. In addition to this condition, this radius is also sufficiently larger such that the second virtual region does not extend outward beyond the second region 30B. As described, this radius is preferably 10 μm or more and 100 μm or less.

In this configuration, the first pattern density ρ₁ refers to the proportion of area occupied by the first nanopillars 33 per unit area in the first region 30A. Meanwhile, the second pattern density ρ₂ refers to the proportion of area occupied by the second nanopillars 34 per unit area in the second region 30B.

The ratio of the second pattern density ρ2 to the first pattern density ρ1, which is ρ2/ρ1, is preferably 0.5 or greater and 2.0 or less (i.e., 0.5 to 2.0), more preferably 0.6 or greater and 1.5 or less (i.e., 0.6 to 1.5), and most preferably 0.8 or greater and 1.2 or less (i.e., 0.8 to 1.2). When the value ρ2/ρ1 falls within the above range, sharp changes in the pattern density near the outer edge of the first region 30A can be effectively suppressed.

As another example, when using electron beam lithography for patterning the nanopillars 32 of the metalens 30, it is desirable that the average exposure amount per nanopillar 32 be substantially equal between the first region 30A and the second region 30B, from the perspective of effectively reducing the proximity effect. In other words, it is desirable that the first average exposure amount E1 per first nanopillar 33 in the first region 30A be substantially equal to the second average exposure amount E2 per second nanopillar 34 in the second region 30B. According to this configuration, the effect of the proximity effect to be caused when using electron beam lithography can be further reduced during the patterning of the first nanopillars 33 located near the outer edge of the first region 30A. For example, the ratio of the second average exposure amount E2 to the first average exposure amount E1, which is E2/E1, is preferably 0.5 or more and 2.0 or less (i.e., 0.5 to 2.0), more preferably 0.6 or more and 1.5 or less (i.e., 0.6 to 1.5), and most preferably 0.8 or more and 1.2 or less (i.e., 0.8 to 1.2).

In addition, when using electron beam lithography for patterning the nanopillars 32, the exposure dose required to form each nanopillar 32 correlates with the volume of each nanopillar 32. For example, in the patterning process for the nanopillars 32, when exposing the patterned portions each composed of the nanopillars 32, the exposure amount required to form each nanopillar 32 has a positive correlation with the volume of each nanopillar 32. In contrast, in the patterning process for the nanopillars 32, when exposing the non-patterned portions each composed of the nanopillars 32, the exposure amount required to form each nanopillar 32 has a negative correlation with the volume of each nanopillar 32.

Hence, it is desirable that the first average volume V1 per first nanopillar 33 in the first region 30A and the second average volume V2 per second nanopillar 34 in the second region 30B are substantially equal to each other. This allows the first average exposure amount E1 provided in the first region 30A and the second average exposure amount E2 provided in the second region 30B to be equal to each other when the electron beam lithography is used for patterning the nanopillars 32. The ratio of the second average volume V2 to the first average volume V1, which is V2/V1, is preferably 0.5 or more and 2.0 or less (i.e., 0.5 to 2.0), more preferably 0.6 or more and 1.5 or less (i.e., 0.6 to 1.5), and most preferably 0.8 or more and 1.2 or less (i.e., 0.8 to 1.2).

A first average volume V1 of the first nanopillars 33 in the first region 30A may be adopted as a value obtained by dividing the total volume of the plurality of first nanopillars 33 in the first region 30A by the total number of the plurality of first nanopillars 33 in the first region 30A. In the same way, a second average volume V2 of the second nanopillars 34 in the second region 30B may be adopted as a value obtained by dividing the total volume of the plurality of second nanopillars 34 in the second region 30B by the total number of the plurality of second nanopillars 34 in the second region 30B.

Similarly, when using electron beam lithography for patterning the nanoholes 42 on the mold 40, it is desirable that the average exposure amount per nanohole 42 be substantially equal to each other between the third region 40A and the fourth region 40B, from the perspective of effectively reducing the proximity effect. In other words, it is desirable that a third average exposure amount E3 per first nanohole 43 in the third region 40A be substantially equal to a fourth average exposure amount E4 per second nanohole 44 in the fourth region 40B. According to this configuration, the influence of the proximity effect caused in using electron beam lithography can be further reduced during the patterning of the first nanoholes 43 corresponding to the first nanopillars 33 located near the outer edge of the first region 30A. For example, the ratio of the fourth average exposure amount E4 to the third average exposure amount E3, i.e., E4/E3, is preferably 0.5 or more and 2.0 or less (i.e., 0.5 to 2.0), more preferably 0.6 or more and 1.5 or less (i.e., 0.6 to 1.5), and most preferably 0.8 or more and 1.2 or less (i.e., 0.8 to 1.2).

Furthermore, when using electron beam lithography for patterning the nanoholes 42, the exposure dose required to form each nanohole 42 correlates with the volume of each nanohole 42. For example, in patterning the nanoholes 42, when exposing the patterned portions composed of the nanoholes 42, the exposure amount required to form each nanohole 42 has a positive correlation with the volume of each nanohole 42. In contrast, in patterning the nanoholes 42, when exposing non-patterned portions composed of the nanoholes 42, the exposure amount required to form each nanohole 42 has a negative correlation with the volume of each nanohole 42.

Hence, it is desirable that the first average volume C1 per first nanohole 43 in the third region 40A and the second average volume C2 per second nanohole 44 in the fourth region 40B are substantially equal to each other. This allows the third average exposure amount E3 in the third region 40A and the fourth average exposure amount E4 in the fourth region 40B to be equal to each other, when using electron beam lithography for patterning the nanoholes 42. For example, the ratio of the second average volume C2 to the first average volume C1, i.e., C2/C1, is preferably 0.5 or more and 2.0 or less (i.e., 0.5 to 2.0), more preferably 0.6 or more and 1.5 or less (i.e., 0.6 to 1.5), and most preferably 0.8 or more and 1.2 or less (i.e., 0.8 to 1.2).

In the present embodiment, as the first average volume C1 of the first nanoholes 43 arranged in the third region 40A, a value can be adopted which is obtained by dividing the total volume of the plurality of first nanoholes 43 in the third region 40A by the total number of the plurality of first nanoholes 43 in the third region 40A. In the same way, as the second average volume C2 of the second nanoholes 44 arranged in the fourth region 40B, a value can be adopted which is obtained by dividing the total volume of the plurality of second nanoholes 44 in the fourth region 40B by the total number of the plurality of second nanoholes 44 in the fourth region 40B.

### Advantages of the Second Embodiment

(2-1) The metalens 30 according to the second embodiment is provided with the plurality of first nanopillars 33 for shifting the phase of light having the specific wavelength. The metalens 30 is also provided with the plurality of second nanopillars 34 arranged in the second region 30B surrounding the first region 30A where the multiple first nanopillars 33 are positioned. This configuration allows the second nanopillars 34 arranged in the second region 30B to suppress formation defects which may be caused in the first nanopillars 33 due to sharp changes in the pattern density near the outer edge of the first region 30A. This enables more precise control of the state of light incident on the multiple first nanopillars 33. In the second embodiment, it is possible to increase the light-gathering efficiency when light incident on the plurality of first nanopillars 33 is focused onto a single point.
(2-2) The ratio ρ2/ρ1 of the second pattern density ρ2 in the second region 30B to the first pattern density ρ1 in the first region 30A is configured to be 0.5 or more and 2.0 or less (i.e., 0.5 to 2.0), preferably 0.6 or more and 1.5 or less (i.e., 0.6 to 1.5), and more preferably 0.8 or more and 1.2 or less (i.e., 0.8 to 1.2). This allows the second nanopillars 34 arranged in the second region 30B to effectively suppress sharp changes in the pattern density near the outer edge of the first region 30A.
(2-3) The effective refractive index owned by the second nanopillars 34 varies in the height direction, thus enabling the second nanopillars 34 to function as Moth-eye structure that minimizes the reflection and refraction of incident light. This prevents the light, which is deviated from the first region 30A, from becoming stray light by reflecting or refracting in the second nanopillars 34. In addition, the metalens 30 according to the second embodiment is also able to contribute to reducing the size of the focal spot provided when focusing light incident on multiple first nanopillars 33 onto a single point.
(2-4) The first nanopillars 33 have rectangular prisms, similarly to the nanopillars 12 of the first embodiment. Thus, the same advantages as those described in the foregoing item (1-2) can be obtained as well.
(2-5) The second phase shift amount φ₂ at each first nanopillar 33 is defined such that the multiple first nanopillars 33 collectively function as a lens. This enables, for example, the metalens 30 according to the second embodiment to function as a condensing lens that focuses light incident on the multiple first nanopillars 33 onto a single point.
(2-6) The ratio V2/V1 of the second average volume V2 of the second nanopillars 34 to the first average volume V1 of the first nanopillars 33 is configured to be 0.5 or more and 2.0 or less (i.e., 0.5 to 2.0), preferably 0.6 or more and 1.5 or less (i.e., 0.6 to 1.5), and more preferably 0.8 or more and 1.2 or less (i.e., 0.8 to 1.2). This allows the first average exposure amount E1 given in the first region 30A and the second average exposure amount E2 given in the second region 30B to be made substantially equal to each other, when using electron beam lithography for patterning the nanopillars 32. As a result, the influence of the proximity effect caused when using electron beam lithography during patterning the nanopillars 32 can be effectively reduced.
(2-7) According to the mold 40 of the second embodiment, during the manufacturing process of the mold 40, it is possible to suppress formation failure of the first nanopillars 43 caused by sharp changes in the pattern density near the outer edge of the third region 40A. Thus, formation defects can be suppressed in the first nanopillars 33, which are caused by the formation defects in the first nanoholes 43. This enables the formation of the multiple first nanopillars 33 that can more accurately control the state of incident light. In addition, the mold 40 suppresses formation defects such as filling defects or residual film thickness variations caused by sharp changes in the pattern density during the transfer process that transfers the multiple nanopillars 32 onto the substrate 31.
(2-8) The ratio C2/C1 of a second average volume C2 of the second nanoholes 44 to a first average volume C1 of the first nanoholes 43 is configured to be 0.5 or more and 2.0 or less (i.e., 0.5 to 2.0), preferably 0.6 or more and 1.5 or less (i.e., 0.6 to 1.5), and more preferably 0.8 or more and 1.2 or less (i.e., 0.8 to 1.2). This allows a third average exposure amount E3 in the third region 40A and a fourth average exposure amount E4 in the fourth region 40B to be made substantially equal to each other when using electron beam lithography for patterning the nanoholes 42. As a result, the influence of the proximity effect caused in using electron beam lithography carried out during patterning the nanoholes 42 can be effectively reduced.

### Modifications of the Second Embodiment

The foregoing second embodiment can still be implemented with the following modifications. Additionally, the modifications may be appropriately combined within the scope of technical feasibility.

The second embodiment has described the metalens 30 having the metasurface structure. Specifically, the second embodiment has exemplified the configuration where a plurality of first nanopillars 33 provided by the metasurface structure collectively function as a condensing lens. Without being limited to this lens structure, for example, the plurality of nanopillars 12 may be configured to function as lenses for phase control for purposes other than the light focusing, as lenses for spectral separation, or as lenses for polarization control. Furthermore, when arranging the multiple first nanopillars 33 on a reflector, the multiple first nanopillars 33 may function in forms other than a lens, such as a configuration for reflecting light of a specific wavelength in an arbitrary direction.

The shape of the first nanopillars 33 is not limited to the rectangular prisms, but, for example, each of the first nanopillars 33 may also be cylindrical. Even in this case, since the first nanopillars 33 possess a uniform effective refractive index in the height direction, it is possible to prevent the shape of the first nanopillars 33 from affecting the transmittance of incident light. Additionally, the shape of the first nanopillars 33 may be any arbitrary shape other than rectangular prisms or cylindrical shapes. For example, the shape of the first nanopillars 33 may be any rectangular prism, such as a square pyramid, or may be a conical prism.

For example, the second nanopillars 34 may refract incident light away from the focal point via a blazed structure.

The effective refractive index of the second nanopillars 34 may be constant in the height direction. In this configuration, the shape and arrangement of the second nanopillars 34 may be determined such that, for example, while the first nanopillars 33 focus the incident light onto a single point or focus, the second nanopillars 34 refract the incident light away from the focus. For example, the second nanopillars 34 may be arranged in an inverted phase state, where the shape and arrangement of the first nanopillars 33 are reversed. According to this arrangement configuration, light deviating from the first region 30A can be suppressed from passing near the focal point as stray light. This also contributes to reducing the focal spot size.

The second nanopillars 34 are not limited to needle-like structures. The second nanopillars 34 may be formed in any shape, such as rectangular prisms with a width W2 greater than the width W1 of the first nanopillars 33, or cylindrical shapes, in which case the diameter corresponds to the width W2. This allows for favorable suppression of formation defects, such as pattern collapse, in the second nanopillars 34. It also effectively suppresses stray light from being caused from the light incident on the second nanopillars 34. Furthermore, since the second nanopillars 34 are configured such that their widths W2 are larger than the widths W1 of the first nanopillars 33, the ratio of the second pattern density ρ2 to the first pattern density ρ1, which is ρ2/ρ1, is greater than 1.0. That is, the ratio ρ2/ρ1 is preferably greater than 1.0 and less than 2.0, and more preferably greater than 1.0 and 1.5 or less.

The shape and arrangement of the second nanopillars 34 adopted in the second region 30B are not limited to the foregoing example, and may be any shape and arrangement. For example, the shape and arrangement of the second nanopillars 34 may be configured to function as an identifier, such as a two-dimensional code. In such a modification, the shape and arrangement of the second nanopillars 34 arranged in the second region 30B can be used, for example, to trace the manufacturing lot and also to authenticate against fake products.

In the metalens 30, the arrangement of the multiple first nanopillars 33 can be appropriately determined according to the applications of the metalens 30. Moreover, the multiple first nanopillars 33 are not limited to a configuration where the first nanopillars 33 are arranged in a square array in the first direction D1 and the second direction D2, the first nanopillars 33 may be arranged radially centered on any point on the substrate 31, by way of example.

The shape and arrangement of the first nanopillars 33 in the first region 30A are not limited to the foregoing example and may be any shape and arrangement. For example, the first embodiment and the second embodiment may be combined in the configurations thereof. That is, in the metalens 30 according to the second embodiment, the plurality of first nanopillars 33 arranged in the first region 30A may be configured such that, similar to the nanopillars 12 according to the first embodiment, the height H1 decreases as the width W1 and volume decrease. In other words, in the metalens 10 according to the first embodiment, the second region 30B may be provided where the second nanopillars 34 are arranged to surround the area where the nanopillars 12 according to the first embodiment are arranged. In such a combined configuration, the modifications of the first embodiment and the modifications of the second embodiment can be combined within the scope that does not technically conflict.

Even when using electron beam lithography for patterning the nanopillars 32 of the metalens 30, the first average exposure amount E1 per first nanopillar 33 and the second average exposure amount E2 per second nanopillar 34 may be set to be different from each other. Furthermore, even when using electron beam lithography for patterning the nanoholes 42 of the mold 40, the third average exposure amount E3 per first nanohole 43 and the fourth average exposure amount E4 per second nanohole 44 may be set to be different from each other.

If it is possible to suppress formation defects of the first nanopillars 33 caused by sharp changes in the pattern density near the outer edge of the first region 30A, the ratio of the second pattern density ρ2 to the first pattern density ρ1, which is denoted as ρ2/ρ1, may be less than 0.5 or greater than 2.0. Additionally, while the first pattern density ρ₁ is defined as the ratio of the occupied area of the first nanopillars 33 within a circular first virtual region, the first virtual region may be any arbitrary area within the first region 30A. For example, the entire first region 30A may be designated as a first virtual region to calculate the first pattern density ρ₁. Similarly, while the second pattern density ρ2 is defined as the ratio of the occupied area of the second nanopillars 34 within a circular second virtual region, a second virtual region may be any area within the second region 30B. For example, the second pattern density ρ2 may be calculated using the entire second region 30B regarded as the second virtual region.

### Examples of the Second Embodiment and Comparative Examples

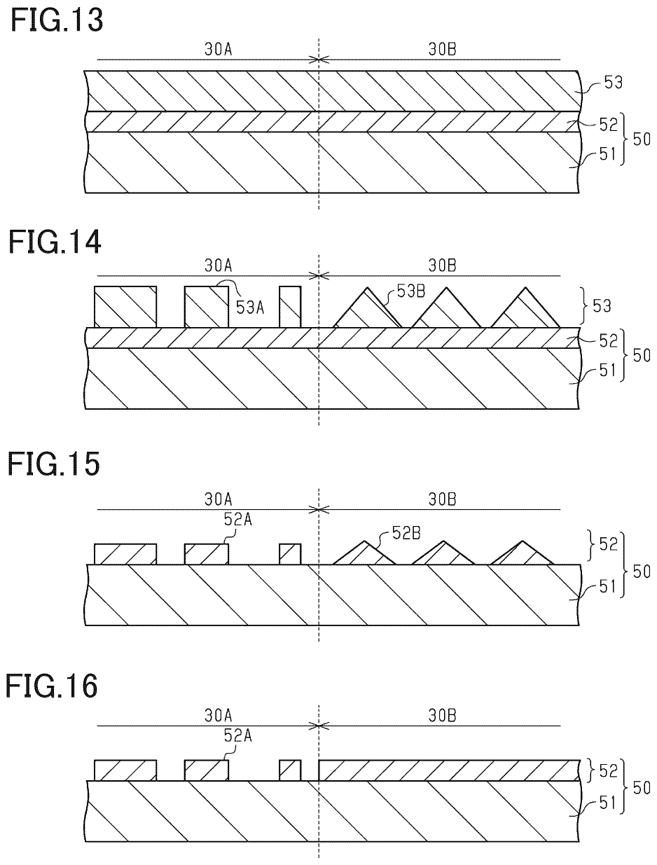

Referring to FIGS. 13 to 16, an Example 2 of the second embodiment and a comparative Example 2 will then be described. It is noted that the following Examples do not limit the scope of the present disclosure.

### Example 2: Fabrication of Metalens

As shown in FIG. 13, in an Example 2, an SOQ wafer 50 was prepared by first depositing a silicon layer 52 with a thickness of 150 nm onto a quartz glass wafer 51 having a diameter of 200 mm. An electron beam photoresist layer 53 with a thickness of 400 nm was then formed on the silicon layer 52 of the SOQ wafer 50. A spin coater was used to form the electron beam photoresist layer 53. The conditions for the spin coater were set to a rotation speed of 700 rpm and a spin time of 120 seconds. Subsequently, the electron beam photoresist layer 53 coated on the SOQ wafer 50 was pre-baked using a hot plate to remove residual solvent contained within the electron beam photoresist layer 53. The pre-bake conditions were a heating temperature of 180 °C and a heating time of 5 minutes.

Next, by exposing the electron beam photoresist layer 53, a pattern of multiple nanopillars 32 was drawn which correspond to the multiple first nanopillars 33 in the first region 30A and the multiple second nanopillars 34 in the second region 30B. An electron beam lithography system was used for this exposure. During the exposure, an electron beam was irradiated at an acceleration voltage of 100 keV.

The first region 30A was formed as a circular shape with a diameter of 2 mm. Within the first region 30A, square dots corresponding to the unexposed area were arranged in a square array with a pitch L of 600 nm. Furthermore, to achieve a phase profile that focuses near-infrared light with a wavelength of 940 nm onto a single point in space, the width of each of the square dots was adjusted within the range of 120 nm to 480 nm according to the dot positions in the first region 30A. The exposure dose for the exposed area, corresponding to the portion of the first region 30A other than the square dots, was set to 150 μC/cm².

The area ratio of the exposed area in the first region 30A was 71%. The percentage of the exposed area refers to the ratio of the exposed area to the sum of the exposed area and the unexposed area in the first region 30A. The average exposure per unit lattice, which is a square with a side length of pitch L, was 106.5 μC/cm².

The second region 30B was formed as a ring with a width W3 of 400 μm (refer to FIG. 11). The second region 30B was arranged to surround the first region 30A. A gradation drawing pattern for forming needle-like structures was arranged in a square array within the second region 30B. The gradation exposure patterns had shapes formed by mutually overlapping squares with mutually different side lengths such that the centers of the squares were coincided. The side lengths of the squares in the gradation exposure patterns were, from the innermost to the outermost, 60 nm, 120 nm, 180 nm, 240 nm, 300 nm, 360 nm, 420 nm, 480 nm, 540 nm, and 600 nm.

In the gradation drawing patterns, different exposure amounts were assigned to the ten areas divided by the ten squares described above. The exposure amounts for the respective areas, from the innermost to the outermost, were set to 15, 30, 45, 60, 75, 90, 105, 120, 135, and 150 μC/cm², respectively. The average exposure per gradation drawing pattern, which was calculated from the area ratios and exposure amounts of the respective areas, was 107.25 μC/cm².

As shown in FIG. 14, development was then performed on the exposed electron beam photoresist layer 53. As a result, rectangle-shaped first transfer nanopillars 53A were formed in the first region 30A. Additionally, needle-shaped second transfer nanopillars 53B were formed in the second region 30B. The first transfer nanopillars 53A and the second transfer nanopillars 53B are composed of the electron beam photoresist layer 53.

Specifically, the exposed area was dissolved by developing the electron beam photoresist layer 53 for 75 seconds using methyl isobutyl ketone. In this process, since the development speed increases with greater exposure, the electron beam photoresist layer 53 remains as needle-shaped second transfer nanopillars 53B in the areas of the gradation exposure pattern. Subsequently, rinsing with ultrapure water removed the developer solution from the electron beam photoresist layer 53 on the SOQ wafer 50, followed by a drying process using a spin dryer. The height of the first transfer nanopillars 53A fabricated through the above process was approximately 320 nm, while the height of the second transfer nanopillars 53B was approximately 250 nm.

As shown in FIG. 15, dry etching was then performed on the SOQ wafer 50 with the electron beam photoresist layer 53. This process transferred the shapes of the first transfer nanopillars 53A and the second transfer nanopillars 53B onto the silicon layer 52 of the SOQ wafer 50. This transfer process formed first nanopillars 52A, which are rectangular prisms composed of the silicon layer 52, in the first region 30A, and formed second nanopillars 52B, which are needle-shaped structures composed of the silicon layer 52, in the second region 30B.

As the etching gas, a mixture containing SF₆ and C₄F₈ was used. The etching time was set to 63 seconds. By adjusting the etching conditions, such as the etching gas, the etching rate of the silicon layer 52 and the etching rate of the electron beam photoresist layer 53 can be set to a correspondence ratio of 1:1. This etching process enables faithful transfer of the shape of the electron beam photoresist layer 53 onto the silicon layer 52. The etching time was set based on the etch rate of the silicon layer 52 to remove exactly 150 nm from both the silicon layer 52 and the electron beam photoresist layer 53.

Finally, the electron beam photoresist layer 53 was removed by a cleaning process. Specifically, the silicon wafer with the electron beam photoresist layer was immersed in a mixture of sulfuric acid and hydrogen peroxide solution (80 °C) for 10 minutes, rinsed with ultrapure water, immersed in a mixture of ammonia and hydrogen peroxide solution at room temperature for 10 minutes, and rinsed with ultrapure water, in this order. Through the above procedure, a metalens provided with the first nanopillars 52A and the second nanopillars 52B was obtained.

The first pattern density ρ₁ of the first nanopillars 52A in the first region 30A was 0.28. The second pattern density ρ₂ of the second nanopillars 52B in the second region 30B was 0.27. As a result, the ratio of the second pattern density ρ₂ to the first pattern density ρ₁ was 1.04 (=ρ2/ρ1).

### Comparative Example 2: Fabrication of the Metalens

In a Comparative Example 2, when exposing the electron beam photoresist layer 53, square dot patterns identical to those of the Example 2 were drawn in the first region 30A, while no pattern was drawn in the second region 30B. For the remaining configurations other than such regional configurations, the metalens shown in FIG. 16 was obtained using the same procedure as those explained in the Example 2.

As shown in FIG. 16, the metalens according to the Comparative Example 2 was provided with the first nanopillars 52A formed by the silicon layer 52 in the first region 30A. In contrast, in the second region 30B, the silicon layer 52 was left in a state where the silicon layer had been deposited.

### Evaluation: Light Gathering Performance Evaluation

An infrared laser light with a wavelength of 940 nm was incident perpendicularly onto the first region 30A of each of the meta-lenses fabricated according to the Example 2 and Comparative Example 2, where the beam diameter φ was 2 mm. Light passing through the metalens was captured by a CCD (Charge Coupled Devices) camera positioned at the focal point. This light intensity distribution was then converted to an intensity distribution on a plane parallel to the metalens and containing the focal point. In the evaluation, a light collection efficiency is defined as a value obtained by dividing the sum of the light intensity distribution within a region centered on the focal point and having a radius of 20 μm by the sum of the light intensity distribution within the φ=2 mm region of the infrared laser. In addition, a half-width of the light intensity distribution within a region centered on the focal point and having a radius of 20 μm is defined as a focal spot diameter.

In the meta-lenses according to the Example 2, the light collection efficiency was 52% and the focal spot diameter was 4.1 μm. For the metalens according to the Comparative Example 2, the light collection efficiency was 46 % and the focal spot diameter was 4.9 μm. Therefore, it was confirmed that forming the second nanopillars 52B in the second region 30B surrounding the first region 30A where the first nanopillars 52A are arranged enables both an increase in the light collection efficiency and a reduction in the focal spot diameter.

What is claimed is:

1. A metasurface structure comprising:
a plurality of nanopillars arranged on a support surface of a substrate, wherein:
the nanopillars have heights and widths such that the smaller the widths, the lower the heights; and
the nanopillars are configured to shift a phase of light having a specific wavelength, depending on positions at which the nanopillars are arranged on the support surface.

2. The metasurface structure according to claim 1, wherein
the nanopillars have a shape of rectangular prism.

3. The metasurface structure according to claim 2, wherein
each of the nanopillars has an aspect ratio of 3.1 or less, the aspect ratio being defined as a ratio of the height to the width.

4. The metasurface structure according to claim 1, wherein
an amount of the phase shift provided by each of the nanopillars is specified such that the plurality of nanopillars collectively function as a lens.

5. A metasurface structure comprising:
a plurality of nanopillars arranged on a support surface of a substrate, wherein:
the nanopillars have volumes and widths such that the smaller the volumes, the lower the heights; and
the nanopillars are configured to shift a phase of light having a specific wavelength, depending on positions at which the nanopillars are arranged on the substrate.

6. A mold comprising:
a plurality of nanoholes for transferring the plurality of nanopillars provided on the metasurface structure according to claim 1 onto the substrate, wherein
the plurality of nanoholes have widths and depths such that the smaller the widths, the shallower the depths.

7. A mold comprising:
a plurality of nanoholes for transferring the plurality of nanopillars provided on the metasurface structure according to claim 5 onto the substrate, wherein
the plurality of nanoholes have volumes and depths such that the smaller the volumes, the shallower the depths.

8. A metasurface structure comprising:
a plurality of nanopillars arranged on a support surface of a substrate, wherein:
the plurality of nanopillars include a plurality of first nanopillars arranged in a first region and a plurality of second nanopillars arranged in an annular second region surrounding the first region, and
the first nanopillars are configured to shift a phase of light having a specific wavelength, depending on positions at which the first nanopillars are arranged on the support surface.

9. The metasurface structure according to claim 8, wherein
when a ratio of an area occupied by the first nanopillars per unit area in the first region is defined as a first pattern density and a ratio of an area occupied by the second nanopillars per unit area in the second region is defined as a second pattern density,
a ratio of the second pattern density to the first pattern density is 0.5 or more and 2.0 or less.

10. The metasurface structure according to claim 8, wherein
the second nanopillars are configured to represent changes in an effective refractive index thereof in a height direction.

11. The metasurface structure according to claim 10, wherein
the first nanopillars have a shape of rectangular prism.

12. The metasurface structure according to claim 8, wherein
the respective first nanopillars are configured to provide the light with a phase shift amount which enables the plurality of first nanopillars to collectively function as a lens.

13. The metasurface structure according to claim 8, wherein
the first nanopillars occupy a first average volume in the first region and the second nanopillars occupy a second average volume in the second region, a ratio of the second average volume to the first average volume being 0.5 or more and 2.0 or less.

14. The metasurface structure according to claim 8, wherein
the second nanopillars have widths which are larger than widths of the first nanopillars.

15. A mold provided with a plurality of nanoholes for transferring, to the substrate, the plurality of nanopillars on the metasurface structure according to claim 8, wherein
the plurality of nanoholes include:
a plurality of first nanoholes for transferring the plurality of first nanopillars to the substrate, the first nanoholes being arranged in a third region; and
a plurality of second nanoholes for transferring the plurality of second nanopillars to the substrate, the second nanoholes being arranged in a fourth region being annular and surrounding the third region.
